(19) United States
(12) Patent Application Publication
(10) Pub. No.: US 2005/0082333 A1
(43) Pub. Date: Apr. 21, 2005

(54) Machine for automatically applying buttons or other metal fittings on a support such as a support fabric, including a mechanism for controlling the overpressure due to the presence of enlarged thickness portions

(76) Inventor: Gaetano Raccosta, Merate (Lecco) (IT)

Correspondence Address: James V. Costigan;Hedman & Costigan, P.C., 1185 Avenue of the Americas, New York, NY, 10036-2646, US

(21) Appl. No.: 11/004,406

(22) Filed: Dec. 3, 2004

(30) Foreign Application Priority Data
May 12, 2003 (IT) MI 2003A 002396

(51) Int. Cl. B25C 5/02

(52) U.S. Cl. 227/18

(57) ABSTRACT

A machine is herein disclosed for automatically applying buttons or other metal fittings in general on a support, of a type comprising loader elements, guide and load rods for feeding parts of the buttons or metal fittings to the support, and punches, respectively a top and a bottom punch, for clamping the button or metal fitting parts on the support, the machine further comprising a telescopic rod for operating the top punch and to hold constant, at the button applying point, a preset pressure value, independently from the presence of possible enlarged thickness portions at the button applying point.

### BACKGROUND OF THE INVENTION

The present invention relates to a machine for automatically applying buttons or other metal fittings in general on a support, such as a fabric support, the machine including a mechanism for controlling or compensating for the excessive pressure or pushing force due to the presence of enlarged thickness portions.

More specifically, the field of the invention is that of the machine used for applying buttons (for example pressure buttons) and other metal fittings in general on a support such as a fabric support or other sheet material support in general.

As is known, prior machines for applying buttons on a fabric piece or sheet conventionally comprise a bottom punch element and a top punch element, the punch elements being driven in different driving directions, so as to mutually clamp, on respective faces of the fabric support, the two parts forming the button to be applied.

Said machines usually comprise moreover load or loading rods entraining respective portions of the buttons to be applied to the driving axis of the punches, said punches in turn operating for pressure crushing the button parts on the fabric support, to clamp said parts on the latter.

A drawback of the above mentioned machines is that the driving means or mechanism included therein for driving or operating the top punch element, are not adapted to provide a reliable holding, on the button parts which must be coupled to one another, of the pressure necessary for closing said button parts, and this, in particular, if the thickness of the support fabric is changed with respect to a rated fixed thickness value based on which the machine is calibrated.

Moreover, in prior machines of the above mentioned type, the load or loading rods are usually driven by a specifically designed servo-mechanism, which is separated from the punch element driving systems.

Such prior solution has the drawback that the machine construction is very complex thereby the machine cannot operate in a reliable manner and must be frequently switched off to repair possible jammings occurring therein.

### SUMMARY OF THE INVENTION

Accordingly, the aim of the present invention is to provide a novel machine for automatically applying buttons and other metal fittings in general, which, with respect to prior like machines, is very simple construction wise and very reliable in operation.

Within the scope of the above mentioned aim, a main object of the present invention is to provide such a machine which is adapted to provide a desired closing force on the punch elements, at the point at which the button is applied to the fabric support, independently from the thickness both of the fabric support and of the parts forming said buttons.

Yet another object of the present invention is to provide such a machine which is further adapted to indicate possible failures in applying the button or metal fittings to the fabric support.

According to one aspect of the present invention, the above mentioned aim and objects, as well as yet other objects, which will become more apparent hereinafter, are achieved by the machine as claimed in claim 1.

Preferred embodiments of the inventive machine are defined in the dependent claims.

Owing to the provision of a driving mechanism including a telescopic system for controlling the displacement of the top punch element, the inventive machine allows to hold a constant pressure on the button being applied, independently from the thickness of the button and the fabric support therefor.

With respect to the prior art in this field, and owing to the unified or standardized mechanism for driving both the punch elements and loading rods, the inventive machine provides moreover the advantage that it is much more simple construction wise and reliable in operation.

Finally, the provision in the system of a load cell allows to indicate possible failures in applying the buttons or metal fittings on the fabric support.

### BRIEF DESCRIPTION OF THE DRAWINGS

The above mentioned and further advantages, objects and features will become more apparent hereinafter from the following detailed disclosure of a preferred embodiment of the invention which is illustrated by way of a non limitative example, in the accompanying drawings, where:

FIG. 1 is a general outlay of the machine according to the present invention;

FIG. 2 is a side elevation view illustrating a detail of the driving mechanisms for driving the punch elements and loading rods, as included in the machine shown in FIG. 1;

FIG. 3 is a schematic view illustrating the conditions of the mechanisms of FIG. 2, as the button parts are loaded toward the button applying region;

FIG. 4 illustrates the details shown in FIG. 3, in a button applying condition;

FIG. 5 illustrates the details of FIG. 3, as a button is applied on a support having an increased thickness;

FIG. 6 is an exploded view illustrating the detail of the top punch element driving system;

FIG. 7 illustrates a further detail of a cam system for adjusting the position of the bottom punch element.

### DESCRIPTION OF THE PREFERRED EMBODIMENTS

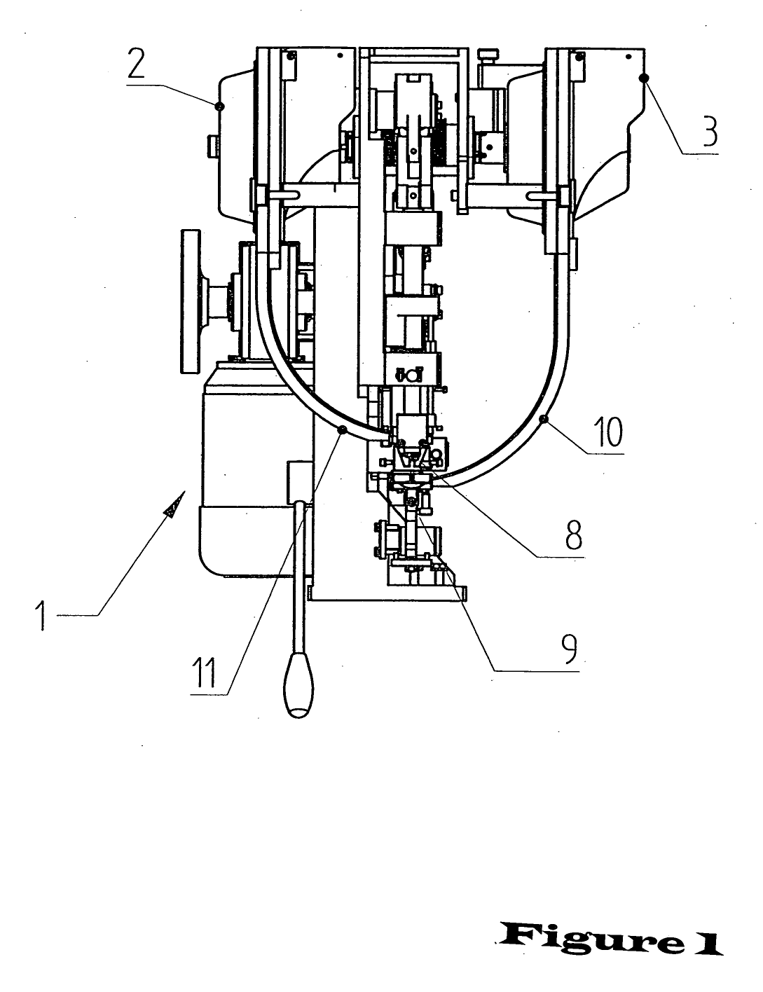

The inventive machine has been generally indicated by the reference number 1 in FIG. 1.

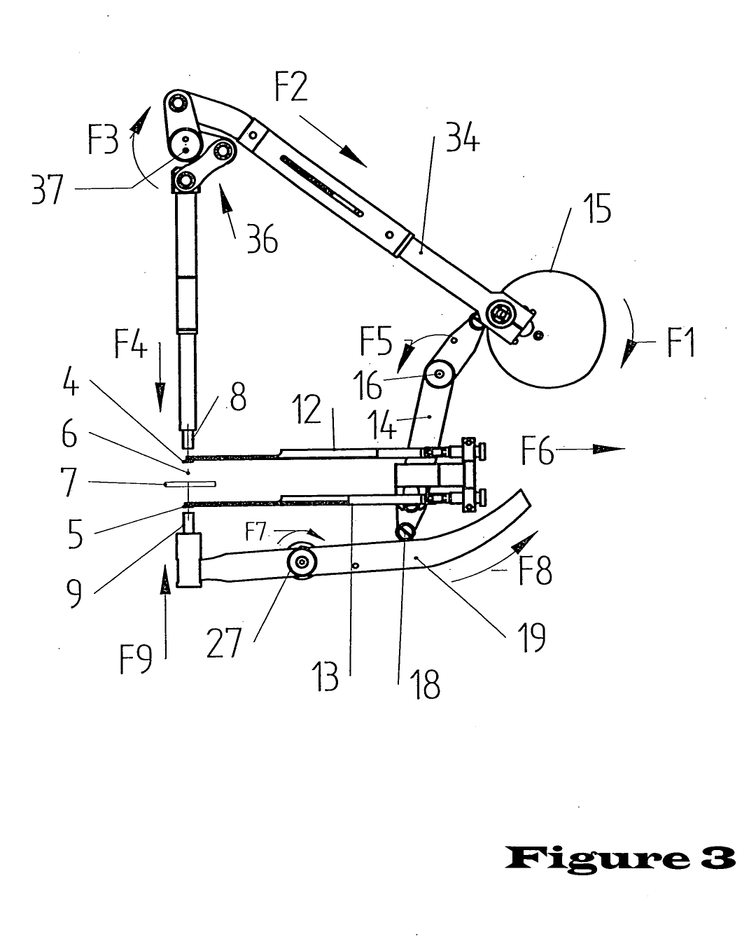

Said machine essentially comprises two loaders 2 and 3 for feeding button parts or components, as respectively indicated by the reference numbers 4 and 5, at a button applying axis 6 for applying said button to a support 7 (for example a support fabric, see FIG. 3).

Said button parts 4 and 5 are moreover driven toward their applying region, thereat operate a top punch element 8 and bottom punch element 9, through respective guides 10 and 11.

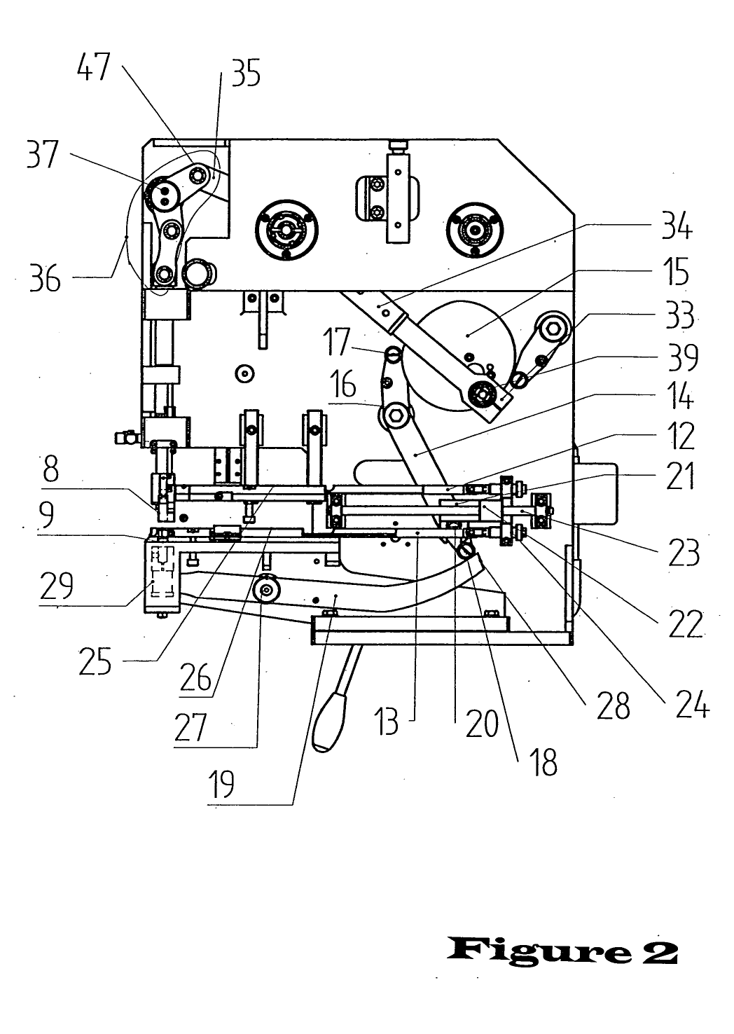

As is clearly shown in FIG. 2, the inventive machine 1 comprises moreover a standardized driving mechanism for driving the bottom punch element 9 and loading rods 12, 13 for loading said button parts 4, 5, said driving mechanism including a control lever 14 driven by a driving cam 15.

Said lever 14 is pivoted on a pivot pin 16 and presents end portions 17, 18 which respectively operate on the cam 15 and a middle lever 19 for controlling the movement of the bottom punch element 9.

On said lever 14 a pawl 20 is moreover provided, which, as it is engaged inside a corresponding fork element 21, drives said loading rods 12 and 13 through a rigid bush assembly 22, rigid with the fork element 21 and designed for sliding on a guide rod 23 and small plate 24 in turn clamped to corresponding end portions of said loading rods 12 and 13.

The front end portions of said loading rods push said respective button parts 4, 5 into corresponding guides 25 and 26, so as to drive them to their applying axis 6.

At a middle position between said lever 14 and bottom punch element 9, a further lever 19 is arranged, said further lever 19 being pivoted on a pivot pin 27 and having an end portion 28 abutting against the roller 18 of the lever 14, whereas the end portion 29 drives the bottom punch element 9.

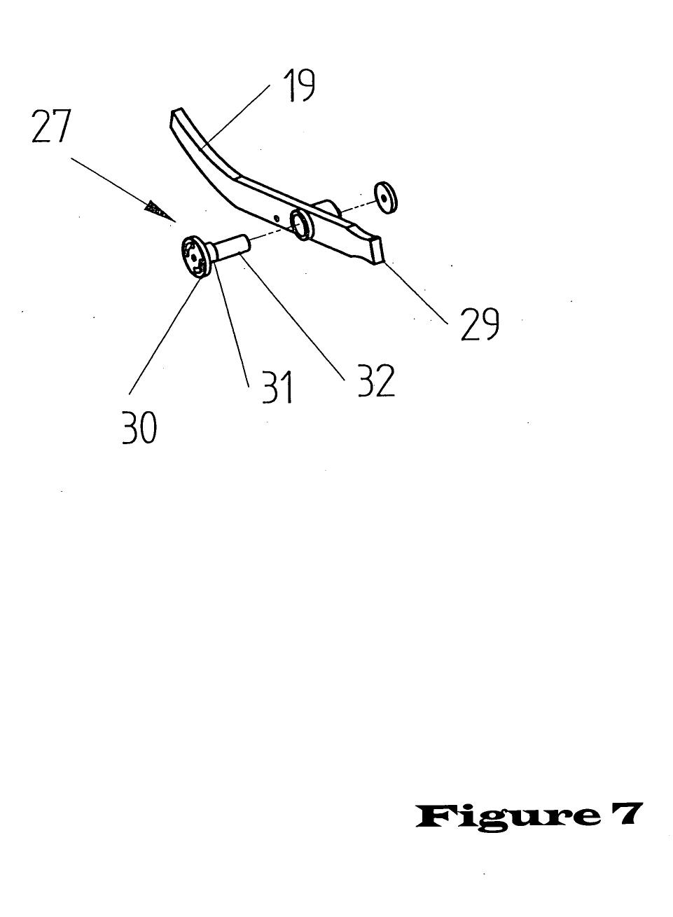

More specifically, the pivot pin 27 of the lever 19 is of a cam or eccentric pivot pin, including a drive disc element 30 (see FIG. 7) having a cylindric portion 31 on the same axis as that of the drive disc, and a further cylindric portion 32 eccentrically arranged with respect to said cylindric portion 31.

Due to the above construction, the vertical position of the lever 19 can be modified by causing the drive disc 30 to turn with respect to the machine body or frame.

On said cam 15, which is driven by a suitable geared unit (not shown), is pivoted an end portion 33 of a telescopic rod 34, the other end portion 35 of which will drive the top punch element 8 through knee joint 36 in turn pivoted to the machine body at its pivot pin 37.

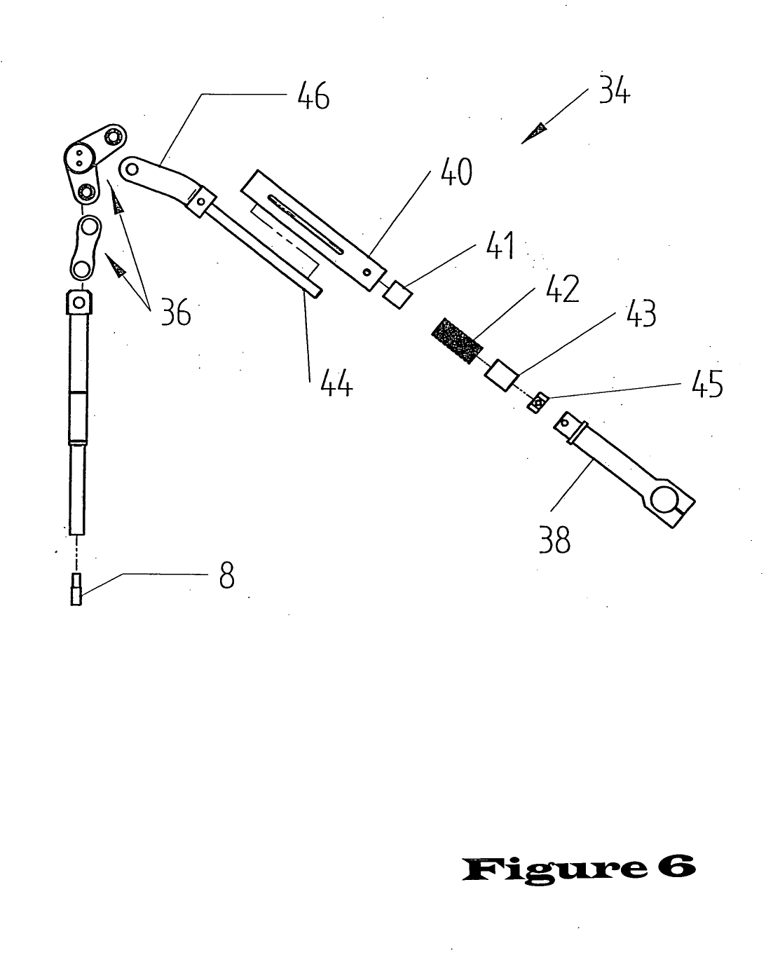

As is clearly shown in FIG. 6, the telescopic rod 34 comprises a bottom arm 38 to be clamped, on a side, to a crank pin 39 of the cam 15 and, at the other side, to the telescopic rod cylinder 40.

Inside said cylinder 40 are moreover arranged, in succession, a loading cell 41, a cup spring pack 42 and a spacer element 43.

This assembly is held in a set position, by pressurizing the spring pack 42, and engaging the threaded bar 44, also arranged inside the cylinder 40, by a nut 45.

A firm connection of the rod construction 34 is made by engaging the arm 38 on a corresponding end portion of the cylinder 40 (in the shown embodiment by engaging a pin, not shown, in respective engaging holes, as shown).

The threaded bar 44 is in turn rigid with the top arm 46 of the rod 34, said top arm 46 being pivoted at 47 on the articulated or knee joint 36 (see FIG. 2).

The preloading condition of the cup spring pack 42 is obtained by screwing on the nut 45 on the threaded bar 44, and being sensed or measured by a loading cell 41.

Thus, as the cam 15 is rotatively driven (according to the arrow F1 of FIG. 3) the following occurs:

the telescopic rod 34 will be driven in the direction of the arrow F2;

the knee joint 36 will be opened by causing it to turn about its pivot pin 37 (arrow F3);

the top punch element 8 will be lowered (arrow F4) in the direction of the button piece or part 4 supported by a respective button grip (not shown);

the lever 14 will be turned about its pivot pin 16 (arrow F5);

the loading rods 12, 13 will be moved away or withdrawn from the button applying region (arrow F6);

the middle lever 19 will be rotatively driven about its pivot pin 27 (arrow F7) by abutting the end portion 18 of the lever 14 against the corresponding portion of the lever 19 (arrow F8);

the bottom punch element 9 will be raised toward the respective button part or piece 5 (arrow F9).

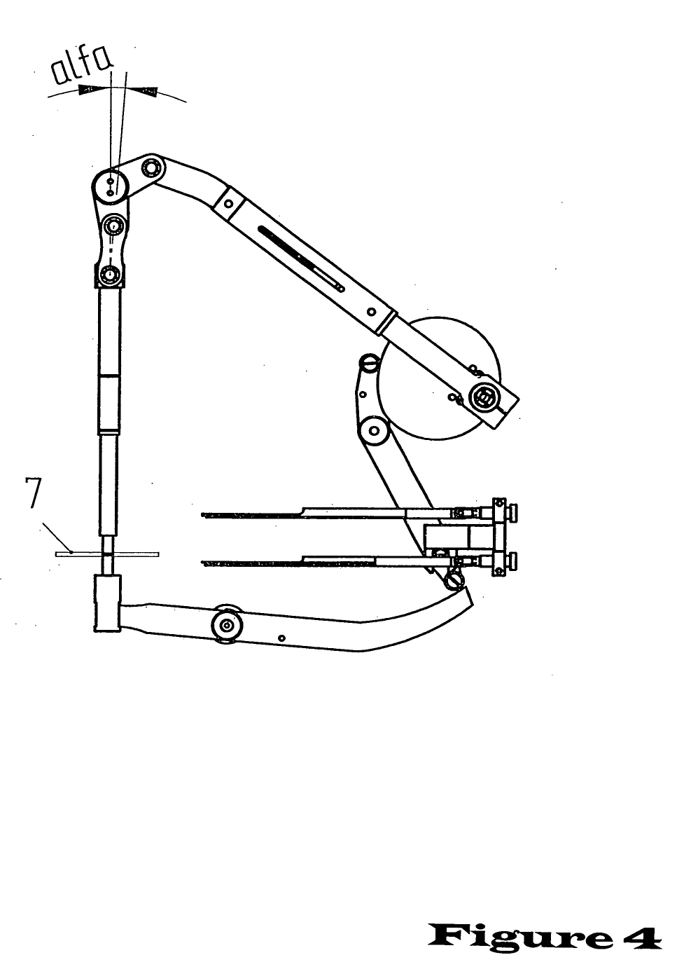

Thus, owing to the above disclosed movements, the button will be brought to its closure or applying condition clearly shown in FIG. 4.

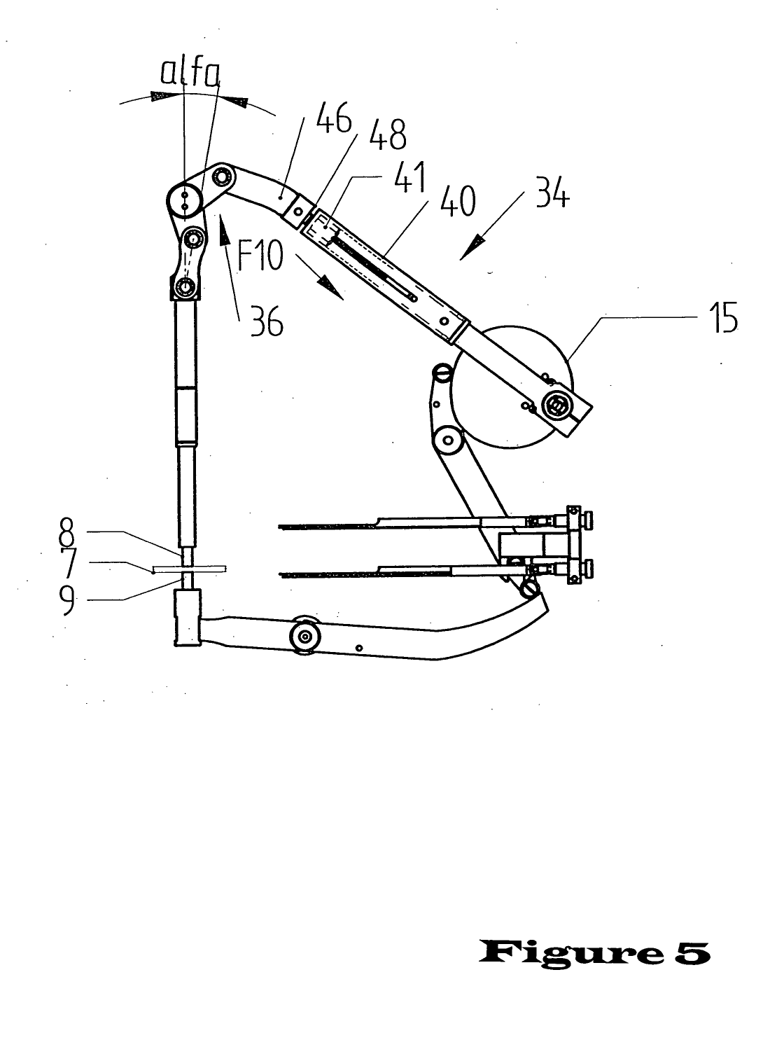

If, in such a closing or closure position, the thickness encountered by the punch elements 8, 9 is larger than the above disclosed one, then the status of the machine will be that shown in FIG. 5.

As is herein shown, in particular, the knee joint 36 has an opening angle f [symbol] larger than that shown in FIG. 4 and the telescopic rod 34 will have its cylindric part 40 slightly removed or displaced away from the corresponding bearing point 48 of the arm 46, by driving that same cylinder 40 in the direction of the arrow F10 of FIG. 5.

This displacement of the cylinder 40 will transfer to the cup spring pack 42, the excess pushing due to the movement of the cam 15 toward its limit position, thereby preventing such excessive pushing from affecting the end portion of the top punch element 8, thereby holding, at the button applying point, a preset pressure value.

The load cell 41, in particular, operates to indicate to an operator a possible excessive or insufficient pushing of the spring, with respect to a present pushing range, which would indicate a failure in the button applying operation.

The machine as disclosed is susceptible to several modifications and variations, all of which will come within the scope of the following claims.

Thus, for example, the telescopic rod 34 can be replaced by a cylinder (either of a pneumatic or of a hydraulic type), the piston of which will affect the knee joint 36 and the pushing force of which would be controlled by a central control unit.

1. A machine for automatically applying buttons or other metal fittings in general on a support, of a type comprising loader devices, guides and loading rods for feeding parts of said buttons or metal fittings toward said support, and punch elements, respectively a top and a bottom punch element, for clamping said parts of buttons and metal fittings on said support, characterized in that said machine further comprises driving means for driving said top punch element, said driving means being adapted to hold constant, at a button applying point at which said button is applied to said support, a preset pressure value, independently from a presence of possible enlarged thickness portions at said button applying point.

2. A machine according to claim 1, characterized in that said driving means comprise a telescopic rod including compensating means for compensating for an excessive pushing due to said top punch element in a presence of said enlarged thickness portions.

3. A machine according to claim 2, characterized in that said machine further comprises a driving cam for driving said top punch element, said telescopic rod including a telescopic rod end portion pivoted to said cam and a further telescopic rod portion rigid with a corresponding end portion of said top punch element through a knee joint, in turn pivoted to a machine body at a pivot pin.

4. A machine according to claim 3, characterized in that said telescopic rod comprises moreover a bottom arm designed to be clamped, on a side, to a crank pin of said cam and, on another side, to a cylinder comprising said telescopic rod.

5. A machine according to claim 4, characterized in that said compensating for means for compensating for an excessive pushing provided by said top punch element as enlarged thickness portions are present, comprises a cup spring pack.

6. A machine according to claim 5, characterized in that in said cylinder are successively arranged a load cell, said cup spring pack and a spacer element.

7. A machine according to claim 6, characterized in that said machine further comprises a threaded bar, also arranged inside said cylinder, said threaded bar having a nut for pressing said cup spring pack.

8. A machine according to claim 3, characterized in that said knee joint, in a presence of said enlarged thickness portions, define an opening angle larger than that which would be present in the absence of said enlarged thickness portions, and said telescopic rod having a cylinder part thereof slightly removed from a corresponding bearing point of a top arm of said rod, by driving said cylinder in a direction of an arrow F10.

9. A machine according to claim 1, characterized in that said compensating for means comprise oleodynamic or pneumatic means in replacement of said telescopic rod and cup spring pack.

10. A machine according to claim 1 or 2, characterized in that said machine comprises moreover a standardized driving mechanism for driving said bottom punch element and loading rods.

11. A machine according to claim 10, characterized in that said standardized mechanism comprises a lever including driving means, and control means for respectively displacing said loading rods and bottom punch element.

12. A machine according to claim 11, characterized in that said lever driving means comprise a driving cam for rotatively driving said lever about a pivot pin therefor.

13. A machine according to claim 11, characterized in that said loading rod driving means comprise a driving pawl rigid with said lever and adapted to cooperate with a corresponding fork element in turn connected to said loading rods through a connecting sliding bush which slides on a guide rod.

14. A machine according to claim 13, characterized in that said machine comprises moreover a clamping plate for clamping said bush to corresponding end portions of said loading rods.

15. A machine according to claim 11, characterized in that said bottom punch element driving means comprise an intermediate lever adapted to cooperate, on a side, with a corresponding end portion of said lever and, on another side, with said bottom punch element.

16. A machine according to claim 15, characterized in that said intermediate lever comprises and eccentric type of fulcrum.

17. A machine according to claim 16, characterized in that said eccentric fulcrum comprises a pin including a drive disc bearing a cylindric portion on a same axis of the drive disc, and a remaining cylindric portion eccentrically arranged with respect to the preceding portion.

18. A machine according to claim 1, characterized in that as said cam is rotatively driven by a geared motor unit (arrow F1), the following occurs:
the telescopic rod is driven in a direction of the arrow F2;
the knee joint is opened by causing it to turn about a pivot pin therefor (arrow F3);
the top punch element is lowered (arrow F4) in the direction of a button part;
the lever is turned about a pivot pin therefor (arrow F5);
the loading rods are withdrawn from the button applying region (arrow F6);
the intermediate lever is rotatively driven about a pivot pin therefor (arrow F7) by causing an end portion of said lever to abut against a corresponding portion of said intermediate lever (arrow F8);
the bottom punch element is raised toward a respective part of said button (arrow F9).

19. A machine according to claim 1, characterized in that said support is a fabric support.
